(19) United States
(12) Patent Application Publication
(10) Pub. No.: US 2024/0204290 A1
(43) Pub. Date: Jun. 20, 2024

(54) BATTERY ASSEMBLY AND BATTERY PACK INCLUDING BATTERY ASSEMBLY

(71) Applicant: SK ON CO., LTD., Seoul (KR)

(72) Inventor: Gang U LEE, Daejeon (KR)

(21) Appl. No.: 18/450,218

(22) Filed: Aug. 15, 2023

(30) Foreign Application Priority Data
Dec. 15, 2022 (KR) 10-2022-0175663
Dec. 15, 2022 (KR) 10-2022-0175664

(51) Int. Cl. H01M 10/6555; H01M 10/613; H01M 50/209; H01M 50/507

(52) U.S. Cl. CPC H01M 10/6555; H01M 10/613; H01M 50/209; H01M 50/507

(57) ABSTRACT

Provided is a battery assembly including: a cell stack including a plurality of battery layers, each battery layer including a plurality of battery cells arranged such that largest surfaces of the battery cells are oriented in a first direction, each battery layer comprising two or more battery rows each including battery cells arranged in a third direction; and one or more busbars configured to electrically connect the plurality of battery cells, wherein the cell stack includes first and second battery rows, electrode terminals of the first and second battery rows are disposed to be oriented in opposite directions based on a reference surface between the first and second battery rows, and the one or more busbars include a transversal busbar configured to connect one or more of the electrode terminals of the first and second battery rows and configured to traverse the reference surface.

### CROSS-REFERENCE TO RELATED APPLICATION(S)

This patent document claims the priorities and benefits of (1) Korean Patent Application No. 10-2022-0175664 filed in the Korean Intellectual Property Office on Dec. 15, 2022, and (2) Korean Patent Application No. 10-2022-0175663 filed in the Korean Intellectual Property Office on Dec. 15, 2022. The disclosure of the above two Korean applications is incorporated herein by reference in their entirety.

This patent document has a related U.S. Application (under Perkins Coie Attorney Docket No. 145658.8055.US00) of the same title and by the same inventor, that was separately filed at the USPTO on the same day of Aug. 15, 2023, and that claims the priority to the same two Korean applications identified above.

### TECHNICAL FIELD

The technology and implementations disclosed in this patent document generally relates to a battery assembly including a plurality of stacked battery cells, such as secondary battery cells, and a battery pack including the same.

### BACKGROUND

Unlike primary batteries, secondary batteries are repeatedly charged and discharged, and thus are applicable to various devices such as digital cameras, mobile phones, notebook computers, hybrid vehicles, electric vehicles and energy storage devices and systems using secondary batteries. Among secondary batteries, lithium secondary batteries having high energy density and discharge voltage are being widely used.

### SUMMARY

An aspect of the disclosed technology provides a battery assembly having high structural rigidity and a simple overall structure, and a battery pack including the same.

Another aspect of the disclosed technology provides a battery assembly capable of simplifying a cooling structure of a cell stack and improving cooling efficiency of the cell stack, and a battery pack including the same.

Another aspect of the disclosed technology provides a battery assembly capable of being easily assembled in a refrigerant supplier, and a battery pack including the same.

Another aspect of the disclosed technology provides a battery assembly capable of improving energy density, and a battery pack including the same.

Another aspect of the disclosed technology provides a battery assembly capable of lowering or easily changing a height of a battery pack, and a battery pack including the same.

In an aspect of the disclosed technology, there is provided a battery assembly including: a cell stack including a plurality of battery layers of battery cells, each battery layer including a plurality of battery cells arranged such that largest surfaces of the battery cells are oriented in a first direction, each battery layer comprising two or more third-direction battery rows each third-direction battery row including the plurality of battery cells arranged in a third direction; and one or more busbars coupled to the plurality of battery cells and configured to electrically connect the plurality of battery cells, wherein the cell stack includes a first second-direction battery row and a second second-direction battery row in which the plurality of battery cells is disposed in a second direction, the first second-direction battery row includes first electrode terminals and electrode terminals of the second second-direction battery row includes second electrode terminals disposed to be oriented in an opposite direction to the first electrode terminals based on a reference surface between the first second-direction battery row and the second second-direction battery row, and the one or more busbars include a transversal busbar configured to connect one or more of the first electrode terminals of the first second-direction battery row and to one or more of the second electrode terminals of the second second-direction battery row and configured to traverse the reference surface.

In some implementations, the one or more busbars may include: a first busbar configured to electrically connect the first electrode terminals of the first second-direction battery row and the second electrode terminals of the second second-direction battery row to an external structure outside the cell stack; and a second busbar structured to connect the first electrode terminals of the first second-direction battery row to each other or the second electrode terminals of the second second-direction battery row to each other.

In some implementations, the first busbar electrically connected to the first second-direction battery row and the first busbar electrically connected to the second second-direction battery row may be disposed at a first end of the cell stack based on the second direction.

In some implementations, the second busbar may be configured to electrically connect electrode terminals of adjacent battery cells in series while electrically connecting electrode terminals provided in the plurality of battery layers in parallel.

In some implementations, the first busbar and the transversal busbar may be disposed in opposite positions of the cell stack based on the second direction.

In some implementations, a portion of the second busbar may connect electrode terminals of adjacent battery cells in each battery layer in series.

In some implementations, the first busbar and the transversal busbar may be disposed in a first end of the cell stack based on the second direction.

In some implementations, the first busbar may include a terminal connection portion connected to the first electrode terminals of the first second-direction battery row or the second electrode terminals of the second second-direction battery row, and an external connection portion for electrical connection to the external structure, and the external connection portion may be exposed to a top surface of the cell stack.

In some implementations, the transversal busbar may include a terminal connection portion connected to the first and second electrode terminals and a transversal portion crossing the reference surface, and the transversal portion may be electrically insulated from the battery cells.

In some implementations, each of the battery cells may include a first side, a second side, and a third side, and the first side may include an area larger than an area of the second side and an area of the third side. The first and second electrode terminals may be disposed on the third side. The first direction may be a direction perpendicular to the first side, the second direction may be a direction perpendicular to the second side, and the third direction may be a direction perpendicular to the third side.

In some implementations, the battery cells may include a prismatic secondary battery having a hexahedral shape.

In some implementations, the battery assembly may further include: a cooling plate disposed between adjacent battery layers and configured to cool the cell stack; and one or more adhesive member structured to fix the cooling plate and the adjacent battery layers.

In some implementations, the cooling plate may be fixed to the adjacent battery layers disposed on both sides in the first direction through the one or more adhesive member.

In another aspect of the disclosed technology, there is provided a battery pack including: a plurality of battery assemblies described above; a pack housing structured to accommodate the plurality of battery assemblies; and an external busbar configured to electrically connect adjacent battery assemblies.

In some implementations, the one or more busbars may include a first busbar configured to electrically connect the first electrode terminals of the first second-direction battery row and the second electrode terminals of the second second-direction battery row to an external structure outside the cell stack.

In some implementations, the first busbar electrically connected to the first second-direction battery row and the first busbar electrically connected to the second second-direction battery row may be disposed in a first end of the cell stack based on the second direction.

In some implementations, the first busbar may include a terminal connection portion connected to the first electrode terminals of the first second-direction battery row or the second electrode terminals of the second second-direction battery row, and an external connection portion for electrical connection to the external busbar, and the external connection portion may be exposed to a top surface of the cell stack.

In some embodiments of the disclosed technology, a first busbar may be disposed at a first end of a cell stack, thereby facilitating a process of connecting an external busbar (e.g., high-voltage busbar) between battery assemblies. In addition, because the first busbar is disposed on a top surface of the cell stack in an exposed state, a process of electrically connecting the external busbar to the first busbar may be easily performed.

In addition, in some embodiments, a cell stack and a cooling plate may be integrated into a single component, thereby increasing structural rigidity and simplifying an overall structure.

In addition, in some embodiments of the disclosed technology, upper and lower battery layers may be cooled through a cooling plate, thereby simplifying a cooling structure of a cell stack and improving cooling efficiency of the cell stack. In some implementations, a wider surface of a battery cell may be in contact with the cooling plate, such that the battery cell and the cooling plate may have a large contact area therebetween. Thus, heat generated in the battery cell may be easily discharged through the cooling plate.

In addition, in some embodiments of the disclosed technology, a direction in which a battery assembly is assembled in a pack housing corresponds to a direction of connection between a cooling plate and a refrigerant supplier, such that the battery assembly may be easily assembled in the refrigerant supplier.

In addition, in some embodiments of the disclosed technology, a cell stack having high rigidity may be directly installed in a pack housing without allowing a module housing to be interposed, thereby improving the energy density of a battery pack.

In addition, in some embodiments of the disclosed technology, the number of layers in which battery cells are stacked may vary depending on an installation environment of a battery pack, thereby lowering and easily changing a height of the battery pack.

### BRIEF DESCRIPTION OF DRAWINGS

The above and other aspects, features, and advantages of the disclosed technology will be more clearly understood from the following detailed description, taken in conjunction with the accompanying drawings, in which:

FIG. 1 is a perspective view of a battery assembly based on some embodiments of the disclosed technology;

FIG. 2 is an exploded perspective view of a battery assembly illustrated in FIG. 1;

FIG. 3 is a plan view of a battery assembly illustrated in FIG. 1;

FIG. 4 illustrates a plurality of battery assemblies illustrated in FIG. 1;

FIG. 5 is an enlarged view of portion “A” of FIG. 4;

FIG. 6 is an enlarged view illustrating a state in which the battery assembly and the refrigerant supplier shown in FIG. 5 are separated from each other;

FIG. 7 is an exploded perspective view illustrating a modification of a battery assembly illustrated in FIG. 1;

FIG. 8 is a perspective view of a battery assembly illustrated in FIG. 7;

FIG. 9 is a perspective view illustrating another example of a battery assembly illustrated in FIG. 1;

FIG. 10 is a perspective view illustrating another example embodiment of a battery assembly illustrated in FIG. 1;

FIG. 11 illustrates a plurality of battery assemblies illustrated in FIG. 10 that are arranged in an array;

FIG. 12 is a perspective view illustrating another example of a battery assembly illustrated in FIG. 10;

FIG. 13 is a perspective view of a battery pack based on some embodiments of the disclosed technology;

FIG. 14 is an exploded perspective view illustrating a busbar connected to a battery assembly illustrated in FIG. 1;

FIG. 15 is a schematic diagram illustrating the current flow of a battery assembly illustrated in FIG. 14;

FIG. 16 illustrates a plurality of battery assemblies illustrated in FIG. 15 that are arranged in an array;

FIG. 17 is an exploded perspective view illustrating another example of a battery assembly illustrated in FIG. 14;

FIG. 18 is a schematic diagram illustrating the current flow of a battery assembly illustrated in FIG. 17;

FIG. 19 illustrates a plurality of battery assemblies illustrated in FIG. 18 that are arranged in an array; and

FIG. 20 is a perspective view of a battery pack based on another example embodiment of the disclosed technology.

### DETAILED DESCRIPTION

Lithium secondary batteries can be manufactured as pouch-type battery cells having flexibility, or prismatic battery cells having rigidity, or cylindrical can-type battery cells.

A plurality of battery cells may be electrically connected to form a cell stack in which the battery cells are stacked, and the cell stack may be accommodated in a module housing to form a battery module. In addition, a plurality of battery modules may be accommodated in a pack housing to form a battery pack.

When the cell stack is installed in the pack housing, there can be a waste of space due to an internal space in the pack housing created by an interposed module housing, and thus the battery pack may have reduced energy density.

In some implementations, a cell-to-pack structure in which the cell stack is directly installed in the pack housing can address such an issue.

However, it may be difficult to form the cell-to-pack structure due to the shape and structure of the integrated cell stack. In some implementations, a cooling structure needs to be installed to cool the cell stack. In addition, it may be difficult to electrically connect a busbar to the cell stack because the busbar connection structure is complicated.

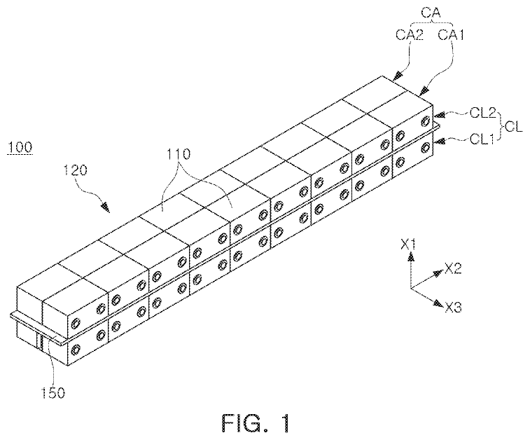

In some embodiments of the disclosed technology, a battery assembly 100 may include specific structures as shown in FIGS. 1 to 6.

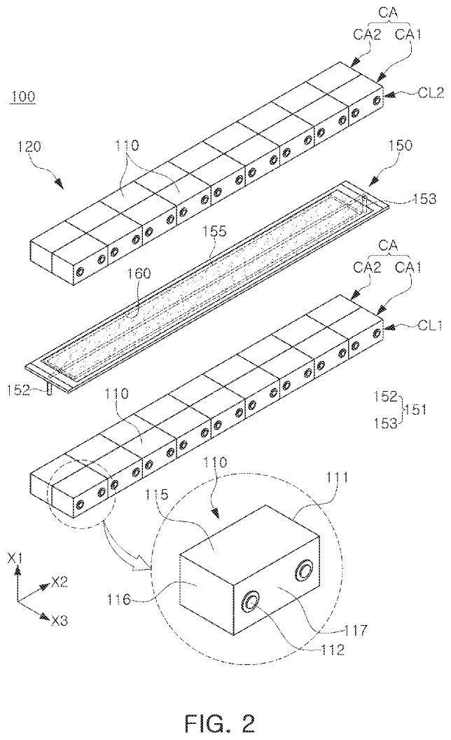

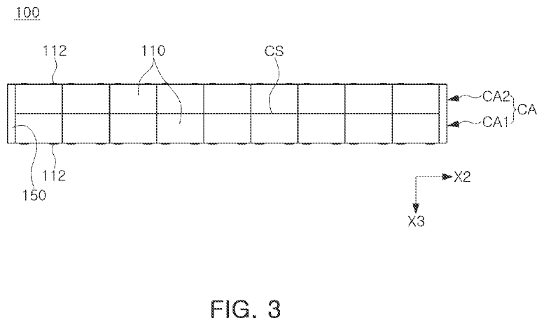

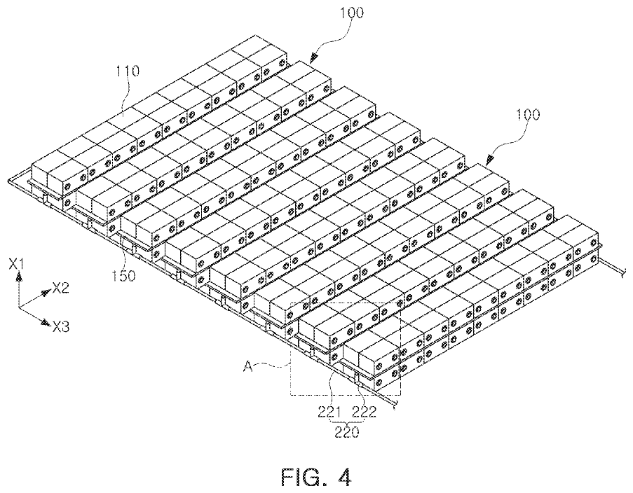

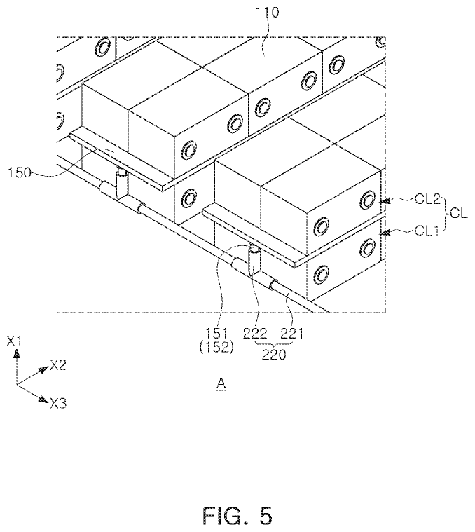

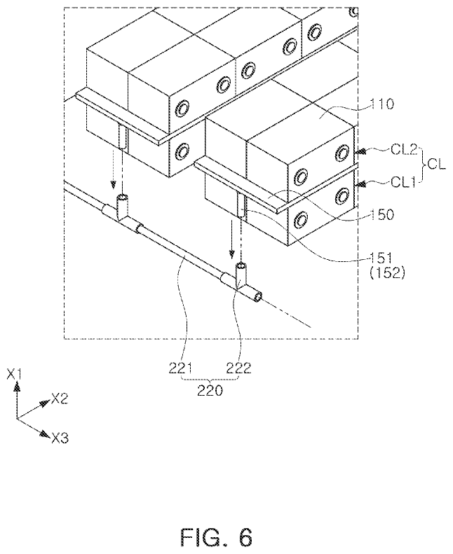

FIG. 1 is a perspective view of a battery assembly 100 based on some embodiments of the disclosed technology. FIG. 2 is an exploded perspective view of the battery assembly 100 illustrated in FIG. 1. FIG. 3 is a plan view of the battery assembly 100 illustrated in FIG. 1. FIG. 4 illustrates a plurality of battery assemblies 100 illustrated in FIG. 1. FIG. 5 is an enlarged view of portion “A” of FIG. 4. FIG. 6 is an enlarged view illustrating a state in which the battery assembly 100 and a refrigerant supplier 220 shown in FIG. 5 are separated from each other.

Referring to FIGS. 1 to 3, the battery assembly 100 based on some embodiments of the disclosed technology may include a cell stack 120, a cooling plate 150, and an adhesive member 160.

The cell stack 120 may include a plurality of battery cells 110. The plurality of battery cells 110 may be disposed in a laid-down state. That is, the battery cell 110 may be disposed such that a widest surface thereof is oriented in a vertical direction.

The battery cell 110 may include a prismatic secondary battery cell having a hexahedral shape. Each battery cell 110 may include an electrode assembly (not illustrated) accommodated in a casing 111, and a plurality of electrode terminals 112 disposed on one side of the casing 111. In some implementations, the electrode terminals 112 are exposed to the outside of the casing 111. The electrode terminals 112 may be electrically connected to the electrode assembly in the casing 111. Each battery cell 110 may include first and second electrode terminals 112 having different polarities. For example, the first electrode terminal 112 may include a positive electrode and the second electrode terminal 112 may include a negative electrode.

Each battery cell 110 may have two first side surfaces 115 facing away from each other, two second side surfaces 116 facing away from each other, and two third side surfaces 117 facing away from each other. The first side surface 115 may have an area larger than those of the second side surface 116 and the third side surface 117. The electrode terminal 112 may be disposed on the third side surface 117. When the battery cell 110 is disposed in a laid-down state, the first side surface 115 may be disposed to be oriented in a vertical direction. Here, a direction that is perpendicular to the first side surface 115 may be referred to as a first direction X1, a direction that is perpendicular to the second side surface 116 may be referred to as a second direction X2, and a direction that is perpendicular to the third side surface 117 may be referred to as a third direction X3. The first direction X1, the second direction X2, and the third direction X3 may be perpendicular to each other.

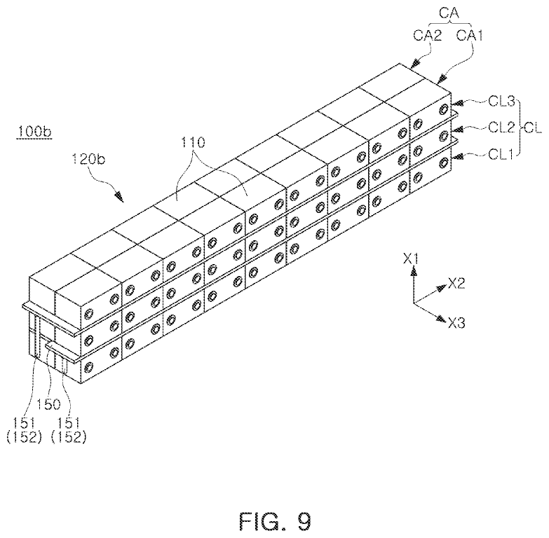

The cell stack 120 may include a plurality of battery layers CL. For example, the cell stack 120 may include two or more battery layers CL stacked in the first direction X1. The plurality of battery layers CL may be formed by stacking the plurality of battery cells 110 arranged in a laid-down state in the first direction X1. The battery layer CL may include a first battery layer CL1 and a second battery layer CL2. Although FIG. 1 shows two battery layers CL1 and CL2 that form the cell stack 120, the cell stack 120 may include three or more battery layers CL (see FIG. 9).

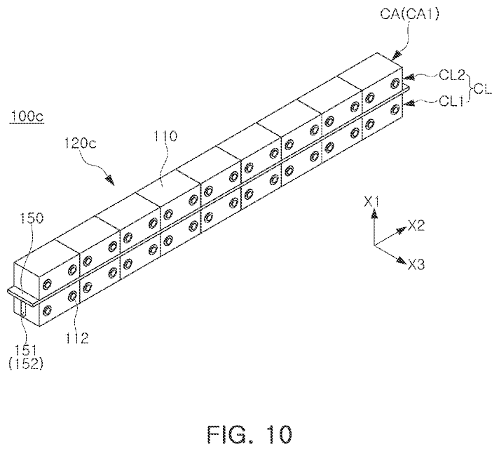

Each of the battery layers CL1 and CL2 may include at least one battery row CA including a plurality of battery cells 110 arranged in a row in the second direction X2. Each of the battery layers CL1 and CL2 may include two or more battery rows CA. For example, the battery row CA may include a first battery row CA1 and a second battery row CA2. The plurality of battery rows CA may be arranged in the third direction X3. That is, the number of battery rows CA may correspond to the number of battery cells 110 disposed in the third direction X3. FIGS. 1 to 3 illustrate two battery rows CA1 and CA2 in each battery layer CL1 and CL2, but the number of battery rows CA provided in each battery layer CL1 and CL2 may vary. For example, as illustrated in FIGS. 10 to 12, each of the battery layers CL1 and CL2 may include one battery row CA. As another example, each of the battery layers CL1 and CL2 may include three or more battery rows CA.

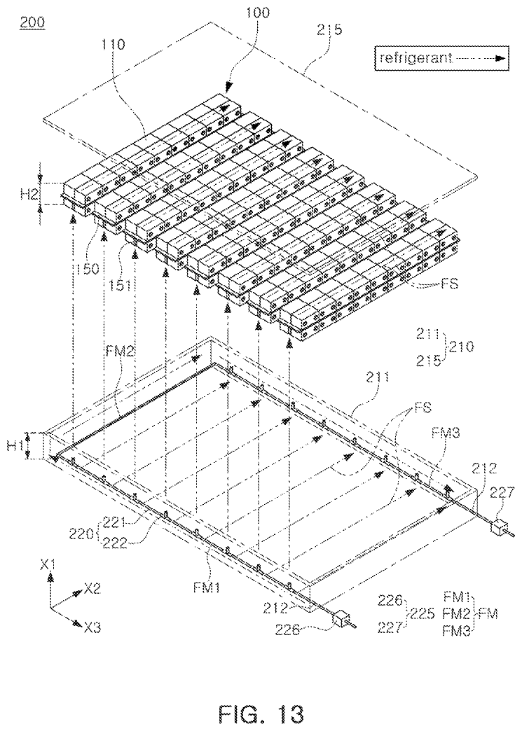

Each of the battery rows CA1 and CA2 may include the same number of battery cells 110. In each of the battery rows CA1 and CA2, the plurality of battery cells 110 may be disposed in the second direction X2, and the second side surfaces 116 of each of the plurality of battery cells 110 face away from each other. In some implementations, a large number of battery cells 110 can form each of the battery rows CA1 and CA2 to fill an internal space of a pack housing (210 in FIG. 13). In one example, four or more battery cells 110 can form each of the battery rows CA1 and CA2. However, the number of battery cells 110 forming each of the battery rows CA1 and CA2 is not limited thereto, and various changes may be made depending on the size of the internal space of the pack housing 210.

The battery cells 110 included in each of the battery rows CA1 and CA2 may be fixed to each other by double-sided tape or others. In addition, the plurality of battery rows CA included in each of the battery layers CL1 and CL2 may be fixed to each other by a double-sided tape or others.

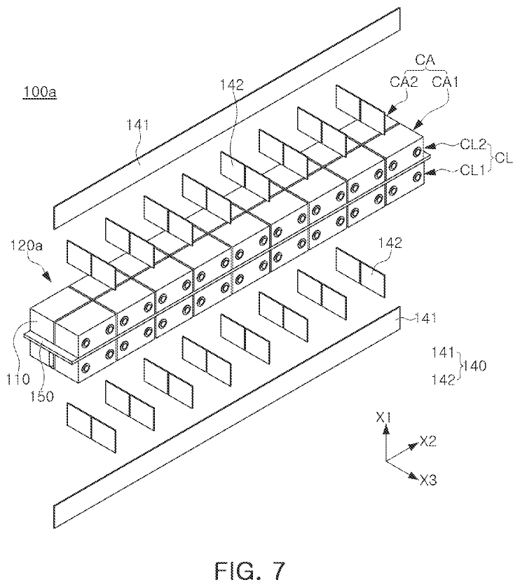

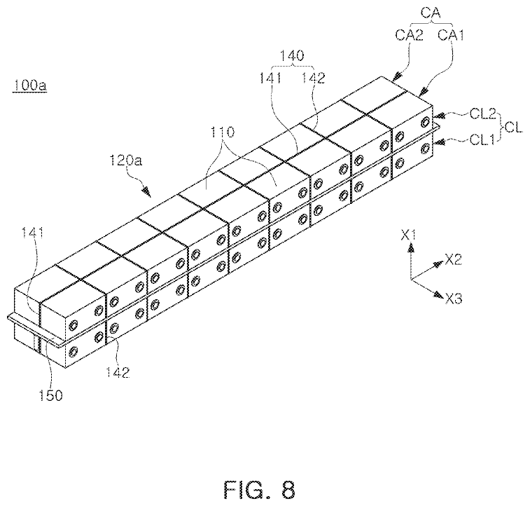

The electrode terminals 112 may be disposed on the third side surface 117 of the battery cell 110. When each of the battery layers CL1 and CL2 includes the first battery row CA1 and the second battery row CA2, the first battery row CA1 and the second battery row CA2 may be coupled to each other, and electrode terminals of the first battery row CA1 and electrode terminals of the second battery row CA2 are oriented in opposite directions with respect to a reference surface between the first battery row CA1 and the second battery row CA2. In some implementations, the reference surface can indicate a surface of the first battery row CA1 and a surface of the second battery row CA2 where the first battery row CA1 and the second battery row CA2 are connected or coupled. Further, in some implementations, the reference surface may be a virtual plane located between adjacent battery rows CA1, CA2. For example, the reference surface may be a plane crossing between adjacent battery rows CA1, CA2 when additional configurations (e.g., cooling fins 141 of FIGS. 7 and 8, etc.) are interposed between battery cells of adjacent battery rows CA1, CA2. Accordingly, the electrode terminals 112 of the battery cell 110 may be exposed toward the outside of the cell stack 120. In some implementations, a reference surface CS may indicate surfaces of the first battery row CA1 and the second battery row CA2 opposing each other and surfaces extending from the surfaces opposing each other.

The cooling plate 150 may be disposed between the plurality of battery layers CL to cool the cell stack 120. That is, the battery layer CL may be positioned on an upper side or a lower side of the cooling plate 150, respectively. The battery cell 110 may be disposed in a laid-down state and the widest first side surface 115 may be disposed to contact and oppose the cooling plate 150, and a contact area between the battery cell 110 and the cooling plate 150 may be increased to enhance transfer of heat from the battery cell 110 to the cooling plate 150. Accordingly, heat generated in the battery cell 110 may be effectively discharged or transferred through the cooling plate 150.

In addition, in some example embodiments, an upper-sided battery layer CL and a lower-sided battery layer CL may be simultaneously cooled through the cooling plate 150, thereby simplifying a cooling structure of the cell stack 120 and improving cooling efficiency of the cell stack 120.

The adhesive member 160 may fix or engage the cooling plate 150 to the battery layer CL. The adhesive member 160 may be disposed on each of both surfaces of the cooling plate 150 in the first direction X1 so that respective adhesive members 160 on both surfaces of the cooling plate 150 can facilitate the transfer of heat from two adjacent battery layers CL on both sides of their shared cooling plate 150 to the shared cooling plate 150.

The cooling plate 150 may be fixed or engaged to each of the battery layers CL disposed on both sides thereof in the first direction X1 through the adhesive member 160. Thus, the cell stack 120 and the cooling plate 150 may be integrated with each other through the adhesive member 160, thereby facilitating heat transfer from the batter layer CL to the cooling plate 150, improving the structural rigidity of the battery assembly 100, and simplifying an overall structure of the battery assembly 100. As described above, according to example embodiments, the battery cell 110 and the cooling plate 150 may have a large contact area therebetween, thereby increasing the adhesive strength between the battery cell 110 and the cooling plate 150. Accordingly, according to example embodiments, a structure for reinforcing the battery assembly 100 may be minimized or eliminated.

The adhesive member 160 may include a thermally conductive adhesive to transfer or conduct heat. The thermally conductive adhesive may fix or engage the cooling plate 150 to the battery layer CL, and may also easily transfer heat generated in the battery cell 110 to the cooling plate 150, thereby contributing to improvement in heat dissipation efficiency and/or cooling efficiency.

The cooling plate 150 may include a cooling passage 155 through which refrigerant (cooling medium) flows. In some implementations, the refrigerant may include a liquid such as cooling water or cooling liquid, and/or a gas such as air. The cooling passage 155 may include a space formed within the cooling plate 150. In addition, the cooling plate 150 may include a connector 151 connected to the cooling passage 155. The connector 151 may have a shape extending in the first direction X1. That is, a connection direction of the connector 151 may be the same as a direction in which the battery assembly 100 is installed in the pack housing (210 in FIG. 13).

The connector 151 may include an inlet 152 for supplying refrigerant to the cooling passage 155 and an outlet 153 for discharging the refrigerant from the cooling passage 155. The inlet 152 and the outlet 153 may be disposed on both sides of the cooling plate 150 in a longitudinal direction X2, respectively. Accordingly, the refrigerant inserted into the cooling passage 155 through the inlet 152 may flow in the longitudinal direction X2 of the cooling plate 150 and then be discharged through the outlet 153. FIG. 2 illustrates the cooling passage 155 branches into three cooling passages, but the shape of the cooling passage 155 is not limited thereto. For example, various changes may be made, and thus the cooling passage 155 may have various shapes such as a non-branching shape, a zigzag shape, or others.

Referring to FIGS. 4 to 6, each of the plurality of battery assemblies 100 may include the cooling plate 150, and each cooling plate 150 may be connected to the refrigerant supplier 220.

The refrigerant supplier 220 may include a refrigerant pipe 221 through which refrigerant is supplied to the cooling plate 150 included in each battery assembly 100 or the refrigerant discharged from the cooling plate 150 flows. The refrigerant pipe 221 may be connected to the connector 151 through the connector 222.

As illustrated in FIG. 6, the connector 151 may have a shape extending in the first direction X1, and a connection port 222 may have a shape extending in the first direction X1 in a position corresponding to that of the connector 151. That is, the connector 151 and the connection port 222 may be arranged and connected to each other in a direction (e.g., X1), which is the same as a direction in which the battery assembly 100 is installed in the pack housing (210 in FIG. 13). Accordingly, the connector 151 of the cooling plate 150 and the refrigerant supplier 220 may be easily connected to each other by moving the battery assembly 100 downwards in the first direction X1.

Subsequently, a modification of the battery assembly 100 illustrated in FIG. 1 will be described with reference to FIGS. 7 and 8.

FIG. 7 is an exploded perspective view illustrating a modification of a battery assembly 100a illustrated in FIG. 1. FIG. 8 is a perspective view of the battery assembly 100a illustrated in FIG. 7.

Similar to the battery assembly 100 illustrated in FIG. 1, the battery assembly 100a illustrated in FIGS. 7 and 8 may include the cell stack 120a, the cooling plate 150, and the adhesive member 160. Different from the battery assembly 100 illustrated in FIG. 1, the battery assembly 100a illustrated in FIGS. 7 and 8 may include a cooling fin 140 as will be discussed below. A thermally conductive adhesive may be disposed between the cooling fin 140 and a side surface of battery cell to transfer or conduct heat.

The cooling fin 140 may be disposed between at least some of the battery cells 110 included in a cell stack 120a, as shown in the examples in FIGS. 7 and 8. The cooling fin 140 may be formed of a material having a high thermal conductivity such as certain metals and other thermal conductive materials. Referring to the specific example in FIG. 8, the cooling fins 140 may be disposed between battery rows and/or battery cells in each row to be in contact with a cooling plate 150 to transfer heat generated in the battery cells 110 first to each cooling fin 140 and then to the cooling plate 150 as additional heat conduct paths to the direct heat transfer from the battery cells in a battery layer to the cooling plate 150. The presence of cooling fins 140 adds more cooling contacts to the battery cells and thus further improve the cooling of the battery stack.

The cooling fin 140 may include at least one of a first cooling fin 141 disposed between the battery rows CA or a second cooling fin 142 disposed between the battery cells 110 in the battery rows CA. The first cooling fin 141 may extend in the second direction X2, and may be disposed between the first battery row CA1 and the second battery row CA2. The first cooling fin 141 may be in contact with a third side surface (117 of FIG. 2) of the battery cell 110. The second cooling fin 142 may extend in the third direction X3, and may be disposed between the battery cells 110 provided in the first battery row CA1 and between the battery cells 110 provided in the second battery row CA2. The second cooling fin 142 may be in contact with a second side surface (116 of FIG. 2) of the battery cell 110.

When both the first cooling fin 141 and the second cooling fin 142 are installed, the cooling fin 140 may be arranged in a lattice.

FIGS. 7 and 8 illustrate example configurations that include the cooling fin 140 disposed to be in contact with all the battery cells 110. In other implementations, the cooling fin 140 may be in contact with some battery cells 110 among the battery cells 110 included in the cell stack 120a.

In some implementations, the battery assembly 100 illustrated in FIG. 1 may be modified as will be discussed below with reference to FIG. 9.

FIG. 9 is a perspective view illustrating another modification of the battery assembly 100 illustrated in FIG. 1.

The battery assembly 100b illustrated in FIG. 9 may be the same as the battery assembly 100 described with reference to FIGS. 1 to 3 in that the cell stack 120b, the cooling plate 150, and the adhesive member 160 are included, and may be different from the battery assembly 100 illustrated in FIG. 1 in that the cell stack 120b includes three battery layers CL.

The cell stack 120b may include three or more battery layers CL. For example, the cell stack 120b may include a first battery layer CL1, a second battery layer CL2, and a third battery layer CL3. The cooling plate 150 may be disposed between the first battery layer CL1 and the second battery layer CL2 and between the second battery layer CL2 and the third battery layer CL3. In addition, each of the battery layers CL1, CL2, and CL3 may include a plurality of battery rows CA1 and CA2.

Each cooling plate 150 may include the connector 151. In this case, the cooling plate 150 disposed between the first battery layer CL1 and the second battery layer CL2 may have a shape not interfering with the connector 151 of the cooling plate 150 disposed between the second battery layer CL2 and the third battery layer CL3.

Subsequently, another example embodiment of the battery assembly 100 illustrated in FIG. 1 will be described with reference to FIGS. 10 to 12.

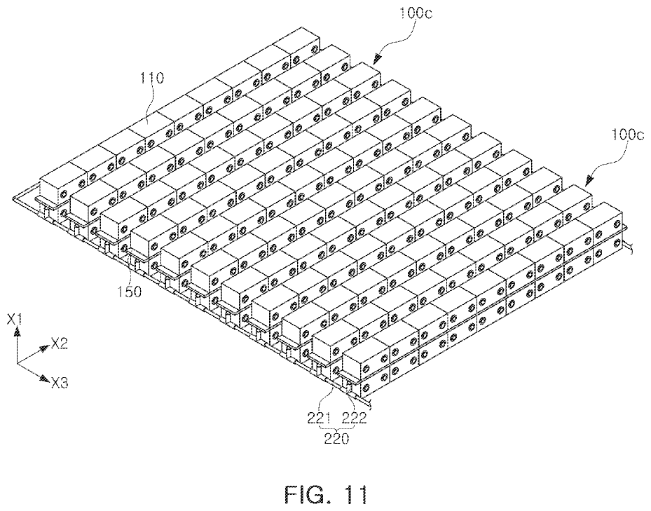

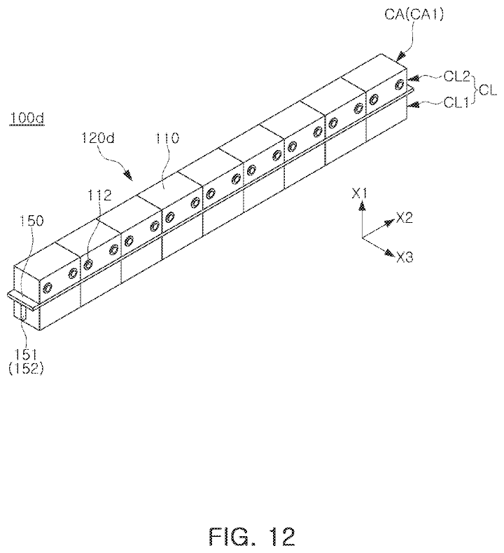

FIG. 10 is a perspective view illustrating another example embodiment of the battery assembly 100 illustrated in FIG. 1. FIG. 11 illustrates a plurality of battery assemblies 100c illustrated in FIG. 10 that are arranged in an array. FIG. 12 is a perspective view illustrating another example of the battery assembly 100c illustrated in FIG. 10.

The battery assembly 100c illustrated in FIGS. 10 and 11 and a battery assembly 100d illustrated in FIG. 12 may be the same as the battery assembly 100 described with reference to FIGS. 1 to 3 in that the cell stack 120c and 120d, the cooling plate 150, and the adhesive member 160 are included, and may be different from the battery assembly 100 illustrated in FIG. 1 in terms of the number of battery rows CA provided in the cell stacks 120c and 120d.

The battery assemblies 100c and 100d illustrated in FIGS. 10 to 12 have a configuration in which only one battery row CA is disposed. That is, the cell stacks 120c and 120d may include only the first battery row CA1 in each of the battery layers CL1 and CL2.

Thus, even when only the first battery row CA1 is included in each of the battery layers CL1 and CL2, the first battery layer CL1 and the second battery layer CL2 may be respectively fixed to upper and lower sides of the cooling plate 150 by an adhesive member (160 in FIG. 2), and thus the battery assembly 100 may have increased rigidity.

In addition, as illustrated in FIG. 11, when the plurality of battery assemblies 100c move in the first direction X1, the cooling plate 150 may be connected to the connection port 222 of the refrigerant supplier 220, such that the battery assembly 100 may have improved ease of assembly.

In the battery assembly 100c illustrated in FIGS. 10 and 11, the electrode terminal 112 disposed on the first battery layer CL1 and the electrode terminal 112 disposed on the second battery layer CL2 may be disposed to be oriented in the same direction. In the battery assembly 100d illustrated in FIG. 12, the electrode terminal 112 disposed on the first battery layer CL1 and the electrode terminal 112 disposed on the second battery layer CL2 may be disposed to be oriented in opposite directions. That is, when each of the battery layers CL1 and CL2 includes only the first battery row CA1, the electrode terminal 112 may be exposed to the outside of the battery assembly 100c and 100d in any direction, thereby easily performing electrical connection between the electrode terminals 112.

Subsequently, a battery pack 200 based on some embodiments of the disclosed technology will be described with reference to FIG. 13.

FIG. 13 is a perspective view of the battery pack 200 based on some embodiments of the disclosed technology.

Referring to FIG. 13, the battery pack 200 based on some embodiments of the disclosed technology may include the above-described battery assembly 100, pack housing 210 and refrigerant supplier 220.

FIG. 13 illustrates a state in which the battery assembly 100 illustrated in FIGS. 1 to 3 is installed. The battery pack 200 based on some embodiments of the disclosed technology may include battery assemblies 100a, 100b, 100c, 100d, 100e, and 100f based on various example embodiments, instead of the battery assembly 100.

The pack housing 210 may accommodate the plurality of battery assemblies 100. The pack housing 210 may include a first housing 211 having a space accommodating the plurality of battery assemblies 100 and a second housing 215 covering the first housing 211. A height H1 of the internal space of the pack housing 210 may correspond to a height H2 of the battery assembly 100. The height H2 of the battery assembly 100 may correspond to the number of battery layers of the battery assembly 100. Accordingly, the number of battery layers included the battery assembly 100 may be set depending on a height of the pack housing 210 required when the battery pack 200 is installed in a vehicle or others. In some example implementations where battery cells are disposed in an upright state, the height of the pack housing may have a predetermined value corresponding to that of a height of each of the battery cells, such that the height of the pack housing may not be easily changed. However, in some example embodiments of the disclosed technology, the battery cells 110 may be arranged in a laid-down state and the number of battery layers may vary, such that the height H1 of the pack housing 210 may be lowered or changed in various manners, depending on the environment the battery pack 200 is in, such as a vehicle or others. For example, the battery assembly 100 include two battery layers, the height H1 of the pack housing may be reduced.

The refrigerant supplier 220 may include the refrigerant pipe 221 through which refrigerant is supplied to the cooling plate 150 included in each battery assembly 100 or the refrigerant discharged from the cooling plate 150 flows. The refrigerant pipe 221 may be connected to the connector 151 through the connection port 222.

Each cooling plate 150 may include the connector 151 extending in the first direction X1, and the connection port 222 may have a shape extending in the first direction X1 in a position corresponding to that of the connector 151. That is, the connector 151 and the connection port 222 may be arranged and connected to each other in a direction (e.g., X1), which is the same as a direction in which the battery assembly 100 is installed in the pack housing 210. Accordingly, the connector 151 of the cooling plate 150 and the refrigerant supplier 220 may be easily connected to each other by moving the battery assembly 100 downward in the first direction X1.

The refrigerant pipe 221 may include an inflow passage FM1 connected to the inlet (152 in FIG. 2) of the cooling plate 150, an outflow passage FM3 connected to the outlet (153 in FIG. 2), and a connection passage FM2 connecting the inflow passage FM1 and the outflow passage FM3 to each other. That is, the refrigerant pipe 221 may form a first passage FM through which refrigerant sequentially flows through the inflow passage FM1, the connection passage FM2, and the outflow passage FM3.

In addition, a portion of the refrigerant flowing through the inflow passage FM1 may be inserted into the inlet (152 in FIG. 2) of the cooling plate 150 through the connection port 222, and may flow through the cooling passage (155 in FIG. 2) through the inlet (152 in FIG. 2) and then may be discharged to the outflow passage FM3 through the outlet (153 in FIG. 2). In this case, the flow of the refrigerant flowing through the cooling passage (155 in FIG. 2) included in each cooling plate 150 may form a second passage FS.

Accordingly, the flow of the refrigerant may branch into the first passage FM and the second passage FS. The first passage FM may include the connection passage FM2, and thus the refrigerant flowing through the first passage FM may be uniformly distributed and supplied to the cooling plate 150 positioned on an upstream side of the first passage FM and the cooling plate 150 positioned on a downstream side of the first passage FM. That is, the cooling plate 150 positioned on the downstream side of the first passage FM may be disposed to be adjacent to the connection passage FM2, and the refrigerant may flow even through the connection passage FM2, such that the refrigerant may be smoothly supplied to the cooling plate 150 positioned on a downstream side of the first passage FM2.

The refrigerant pipe 221 may be connected to a pump 225 installed to supply refrigerant. The pump 225 may include a pressure pump 226 connected to an upstream side of the inflow passage FM1 and a suction pump 227 connected to a downstream side of the outflow passage FM3. The pressure pump 226 may pressurize the refrigerant to supply the refrigerant to the inflow passage FM1, and the suction pump 227 may provide suction force to suction the refrigerant from the outflow passage FM3.

An opening 212 through which the refrigerant pipe 221 passes may be formed in the first housing 211.

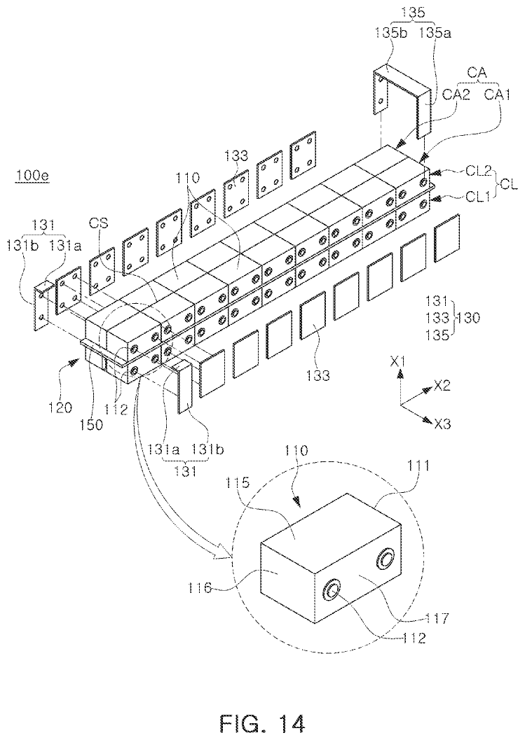

Subsequently, electrical connection of the battery assembly 100e will be described with reference to FIGS. 14 to 16.

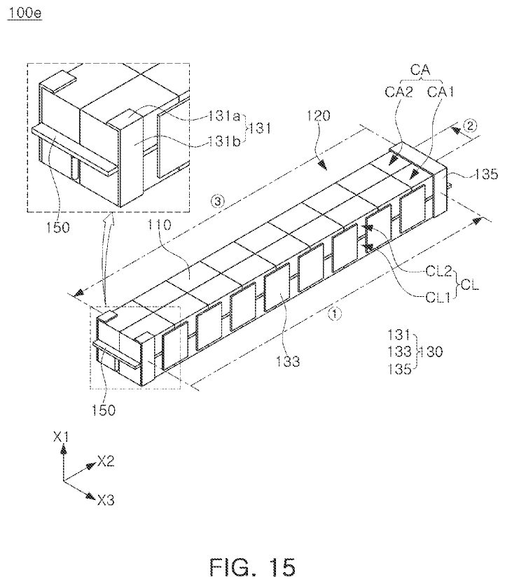

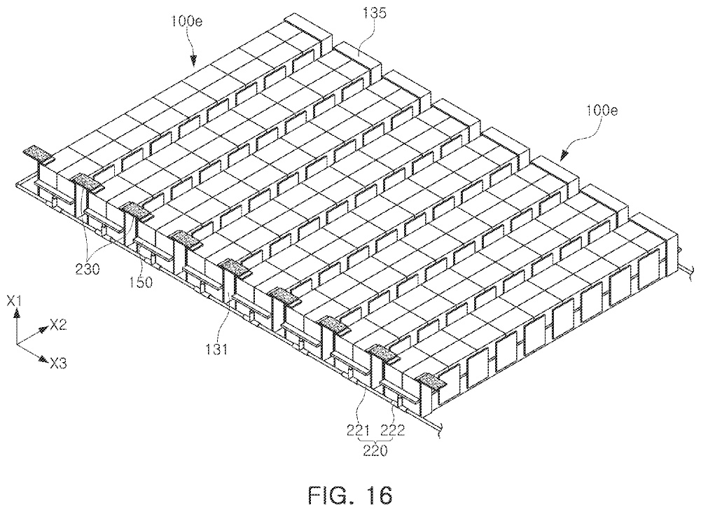

FIG. 14 is an exploded perspective view illustrating an example of a busbar 130 connected to the battery assembly 100 illustrated in FIG. 1. FIG. 15 is a schematic diagram illustrating the current flow of the battery assembly 100e illustrated in FIG. 14. FIG. 16 is a schematic diagram illustrating the plurality of battery assemblies 100e illustrated in FIG. 15.

The battery assembly 100e illustrated in FIGS. 14 to 16 may be the same as the battery assembly 100 described with reference to FIGS. 1 to 3 in that the cell stack 120, the cooling plate 150, and the adhesive member 160 are included, and may be different from the battery assembly 100 illustrated in FIG. 1 in that the busbar 130 is further included.

In the cell stack 120, the plurality of battery cells 110 arranged in a laid-down state may be disposed to form the plurality of battery layers CL in the first direction X1, and to form two or more battery rows CA in the third direction X3. The cell stack 120 may include two battery rows CA, but is not excluded to include three or more battery rows CA. The cell stack 120 may include two battery layers CL, but may also include three or more battery layers CL. The cell stack 120 may include the first battery row CA1 and the second battery row CA2 in which the plurality of battery cells 110 are disposed in the second direction X2. The electrode terminals 112 of the first battery row CA1 and the electrode terminals 112 of the second battery row CA2 may be oriented in opposite directions with respect to the reference surface CS between the first battery row CA1 and the second battery row CA2.

The busbar 130 may electrically connect the plurality of battery cells 110 to each other. The busbar 130 may include a first busbar 131 used to electrically connect the electrode terminal 112 of the first battery row CA1 and the electrode terminal 112 of the second battery row CA2 to the outside of the cell stack 120, and a second busbar 133 connecting, to each other, the electrode terminals 112 of the first battery row CA1 and the electrode terminals 112 of the second battery row CA2. In addition, the busbar 130 may include a transversal busbar 135 traversing the reference surface CS. The transversal busbar 135 may connect a portion of the electrode terminals 112 of the first battery row CA1 and a portion of the electrode terminals 112 of the second battery row CA2, to each other.

The first busbar 131 may include a terminal connection portion 131b connected to the electrode terminal 112 of the first battery row CA1 or the electrode terminal 112 of the second battery row CA2 and an external connection portion 131a for electrical connection to the outside. The external connection portion 131a may be exposed to an upper surface of the cell stack 120. Accordingly, when the first busbar 131 of the plurality of battery assemblies 100e is electrically connected by an external busbar 230, the installation work of the external busbar 230 may be facilitated.

In addition, the first busbar 131 of the first battery row CA1 and the first busbar 131 of the second battery row CA2 may be disposed on one side (first end) of the cell stack 120 with respect to the second direction X2. Thus, the first busbar 131 disposed on one side of the cell stack 120 may facilitate a process of connecting the plurality of battery assemblies 100e to each other through the external busbar 230, as compared to when the first busbar 131 is disposed on both sides of the cell stack 120. In addition, the first busbars 131 of the plurality of battery assemblies 100e may have a short distance therebetween, and thus the external busbar 230 may have a shortened length.

The second busbar 133 may connect, to each other, the electrode terminals 112 of the battery cell 110, adjacent to each other, in series while connecting, to each other, the electrode terminals 112 of the plurality of battery layers CL in parallel. The second busbar 133 may connect, to each other, the electrode terminal 112 provided in the first battery layer CL1 and the electrode terminal 112 provided in the second battery layer CL2 in parallel. In addition, the second busbar 133 may connect the electrode terminals 112 of the battery cell 110, adjacent to each other, in the first battery layer CL1 and the electrode terminals 112 of the battery cell 110, adjacent to each other, in the second battery layer CL2 in series. That is, the second busbar 133 may connect adjacent battery cells 110 to each other in series in the third direction X3 while connecting the number of battery cells 110 corresponding to the number of battery layers CL in parallel.

The transversal busbar 135 may include a terminal connection portion 135a connected to the electrode terminal 112 and a transversal portion 135b traversing the reference surface CS. The transversal portion 135b may be disposed in an insulated state from the battery cell 110. In FIG. 14, the transversal portion 135b is illustrated as having a shape traversing the first side surface 115 of the battery cell 110, but the transversal portion 135b may have a shape traversing the second side surface 116 of the battery cell 110.

The first busbar 131 and the transversal busbar 135 may be disposed in opposite positions of the cell stack 120 with respect to the second direction X2.

Referring to FIG. 15, a current passage of the battery assembly 100e may include a first passage “\textcircled{1}” through which current flows to the transversal busbar 135 on a side of the first battery row CA1 through the first busbar 131 of the first battery row CA1 and the second busbar 133 of the first battery row CA1, a second passage “\textcircled{2}” through which current flows from the first battery row CA1 to the second battery row CA2 through the transversal busbar 135, and a third passage “\textcircled{3}” through which current flows to the first busbar 131 of the second battery row CA2 through the transversal busbar 135 on a side of the second battery row CA2 and the second busbar 133 of the second battery row CA2.

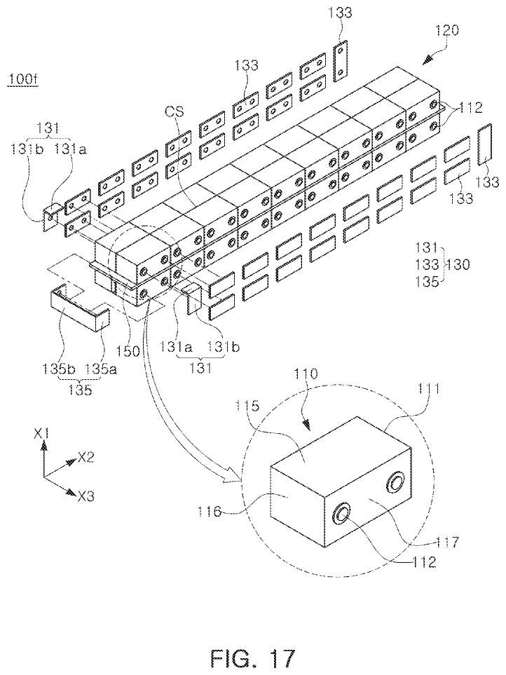

Subsequently, electrical connection of another example of the battery assembly 100f will be described with reference to FIGS. 17 to 19.

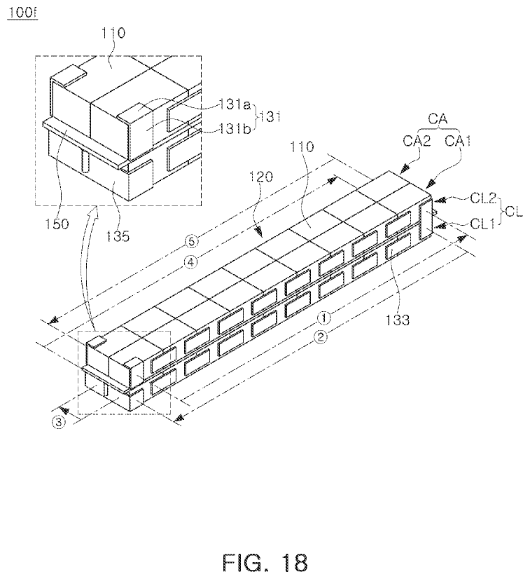

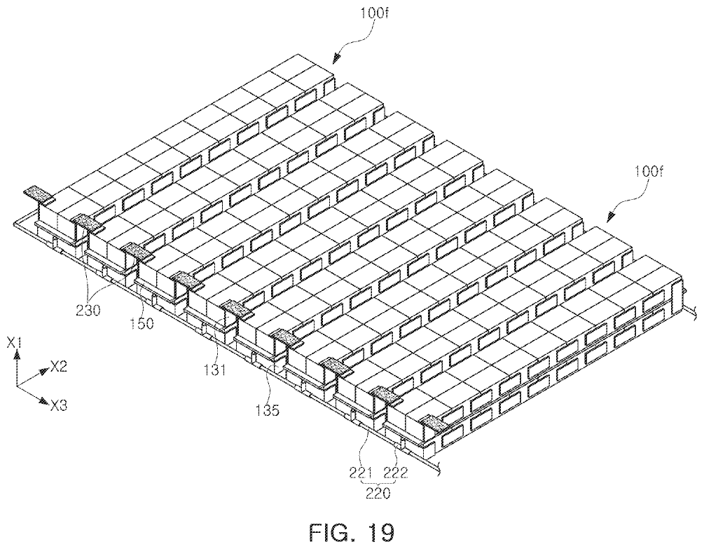

FIG. 17 is an exploded perspective view illustrating another example of the battery assembly 100e illustrated in FIG. 14. FIG. 18 is a schematic diagram illustrating the current flow of the battery assembly 100f illustrated in FIG. 17. FIG. 19 illustrates the plurality of battery assemblies 100f illustrated in FIG. 18 that are arranged in an array.

The battery assembly 100f illustrated in FIGS. 17 to 19 may be the same as the battery assembly 100 described with reference to FIGS. 1 to 3 in that the cell stack 120, the cooling plate 150, and the adhesive member 160 are included, and may be different from the battery assembly 100 illustrated in FIG. 1 in that the busbar 130 is further included. In addition, the battery assembly 100f illustrated in FIGS. 17 to 19 may be different from the battery assembly 100e described with reference to FIGS. 14 to 16 only in terms of a shape and arrangement of the busbar 130.

In a similar manner to the battery assembly 100e described with reference to FIGS. 14 to 16, the busbar 130 may include the first busbar 131, the second busbar 133, and the transversal busbar 135. The first busbar 131 may be used to electrically connect the electrode terminal 112 of the first battery row CA1 and the electrode terminal 112 of the second battery row CA2 to the outside of the cell stack 120. The second busbar 133 may connect, to each other, the electrode terminals 112 of the first battery row CA1 and the electrode terminals 112 of the second battery row CA2. The transversal busbar 135 may traverse the reference surface CS. The transversal busbar 135 may connect a portion of the electrode terminals 112 of the first battery row CA1 and a portion of the electrode terminals 112 of the second battery row CA2, to each other.

The first busbar 131 may include terminal connection portion 131b connected to the electrode terminal 112 of the first battery row CA1 or the electrode terminal 112 of the second battery row CA2 and the external connection portion 131a for electrical connection to the outside. The external connection portion 131a may be exposed to an upper surface of the cell stack 120. The terminal connection portion 131b may be connected to the electrode terminal 112 of the battery cell 110 disposed on the second battery layer CL2, and the external connection portion 131a may be exposed to an upper surface of the battery cell 110 disposed on the second battery layer CL2.

Some of the second busbars 133 may connect, to each other, the electrode terminals 112 of the battery cell 110, adjacent to each other, in each of the battery layers CL1 and CL2 in series. That is, the second busbar 133 may connect, to each other, the electrode terminals 112 of the battery cell 110, adjacent to each other, in the first battery layer CL1 in series or may connect, to each other, the electrode terminals 112 of the battery cell 110, adjacent to each other, in the second battery layer CL2 in series. Some of the second busbars 133 may connect the electrode terminals 112 of the battery cell 110, adjacent to each other, in the first battery row CA1 and the second battery row CA2 in series.

The transversal busbar 135 may include the terminal connection portion 135a connected to the electrode terminal 112 and the transversal portion 135b traversing the reference surface CS. The transversal portion 135b may be disposed in an insulated state from the battery cell 110. In FIG. 17, the transversal portion 135b is illustrated as having a shape traversing the second side surface 116 of the battery cell 110, but the transversal portion 135b may have a shape traversing the first side surface (lower surface) 115 of the battery cell 110 disposed on the first battery layer CL1.

The first busbar 131 and the transversal busbar 135 may be disposed on the same side surface of the cell stack 120 with respect to the second direction X2.

Referring to FIG. 18, a current passage of the battery assembly 100f may include a first passage “\textcircled{1}” through which current flows along the second battery layer CL2 from the first battery row CA1, a second passage “\textcircled{2}” through which current flows along the first battery layer CL1 from the first battery row CA1, a third passage “\textcircled{3}” through which current flows from the first battery layer CL1 of the first battery row CA1 to the first battery layer CL1 of the second battery row CA2 through the transversal busbar 135, a fourth passage “\textcircled{4}” through which current flows along the first battery layer CL1 from the second battery row CA2, and a fifth passage “\textcircled{5}” through which current flows along the second battery layer CL2 from the second battery row CA2.

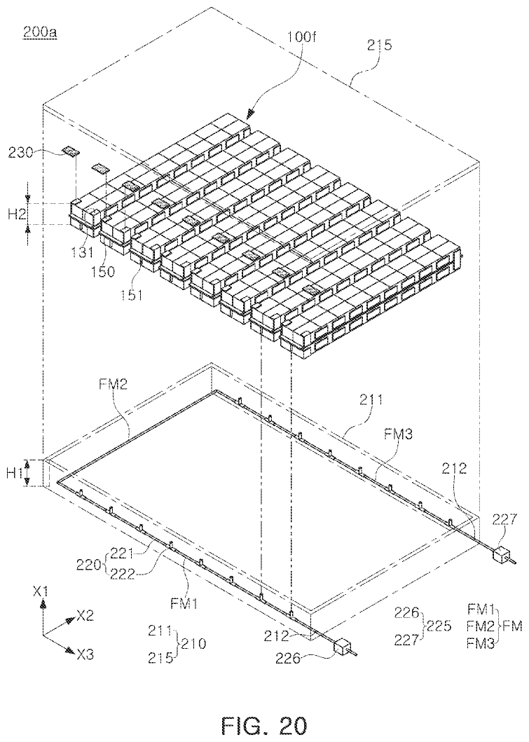

FIG. 20 is a perspective view of the battery pack 200a based on some embodiments of the disclosed technology.

Referring to FIG. 20, the battery pack 200a based on some embodiments of the disclosed technology may include the battery assembly 100f and the pack housing 210 described above, in the same manner as the battery pack 200 described in FIG. 13, and the battery pack 200a may further include the refrigerant supplier 220.

FIG. 20 illustrates a state in which the battery assembly 100f illustrated in FIGS. 17 to 19 is installed. The battery pack 200a based on some embodiments of the disclosed technology may include battery assemblies 100, 100a, 100b, 100c, 100d, and 100e according to various modifications or example embodiments, instead of the battery assembly 100f.

The pack housing 210 may accommodate the plurality of battery assemblies 100f. The pack housing 210 may include the first housing 211 having a space accommodating the plurality of battery assemblies 100f and the second housing 215 covering the first housing 211.

The refrigerant supplier 220 may include the refrigerant pipe 221 through which refrigerant is supplied to the cooling plate 150 included in each battery assembly 100f or the refrigerant discharged from the cooling plate 150 flows. The refrigerant pipe 221 may be connected to the connector 151 through the connection port 222.

The configurations of the pack housing 210 and the refrigerant supplier 220 may be the same as or similar to those of the example embodiment of FIG. 13.

The battery pack 200a illustrated in FIG. 20 may include the external busbar 230 electrically connecting, to each other, battery assemblies 100f, adjacent to each other. The external busbar 230 may electrically connect the first busbar 131 provided in the plurality of battery assemblies 100f in the first direction X1. The external busbar 230 may include a high-voltage (HV) busbar.

The first busbar 131 provided in the plurality of battery assemblies 100f may be in a state of being exposed to an upper surface of the battery assembly 100f, and may be disposed on one side of the battery assembly 100f, thereby easily performing a process of electrically connecting the external busbar 230 to the first busbar 131.

The disclosed technology can be implemented in the field of secondary batteries or rechargeable batteries that widely used in battery-powered devices or systems, including, e.g., digital cameras, mobile phones, notebook computers, hybrid vehicles, electric vehicles, uninterruptible power supplies, battery storage power stations, and others including battery power storage for solar panels, wind power generators and other green tech power generators. Specifically, the disclosed technology can be implemented in some embodiments to provide improved electrochemical devices such as a battery, thereby mitigating climate change. Lithium secondary batteries based on the disclosed technology can be used to address various adverse effects such as air pollution and greenhouse emissions by powering electric vehicles (EVs) as alternatives to vehicles using fossil fuel based engines and by providing battery based energy storage systems (ESSs) to store renewable energy such as solar power and wind power.

Only specific examples of implementations of certain embodiments are described. Variations, improvements and enhancements of the disclosed embodiments and other embodiments may be made based on the disclosure of this patent document.

What is claimed is:

1. A battery assembly comprising:
a cell stack including a plurality of battery layers of battery cells, each battery layer including a plurality of battery cells arranged such that largest surfaces of the battery cells are oriented in a first direction, each battery layer comprising two or more third-direction battery rows each third-direction battery row including the plurality of battery cells arranged in a third direction; and
one or more busbars coupled to the plurality of battery cells and configured to electrically connect the plurality of battery cells,
wherein the cell stack includes a first second-direction battery row and a second second-direction battery row in which the plurality of battery cells is arranged in a second direction,
the first second-direction battery row includes first electrode terminals and the second second-direction battery row includes second electrode terminals disposed to be oriented in an opposite direction to the first electrode terminals based on a reference surface between the first second-direction battery row and the second second-direction battery row, and
the one or more busbars include a transversal busbar configured to connect one or more of the first electrode terminals of the first second-direction battery row to one or more of the second electrode terminals of the second second-direction battery row and configured to traverse the reference surface.

2. The battery assembly of claim 1, wherein the one or more busbars include:
a first busbar configured to electrically connect the first electrode terminals of the first second-direction battery row and the second electrode terminals of the second second-direction battery row to an external structure outside the cell stack; and
a second busbar structured to connect the first electrode terminals of the first second-direction battery row to each other or the second electrode terminals of the second second-direction battery row to each other.

3. The battery assembly of claim 2, wherein the first busbar electrically connected to the first second-direction battery row and the first busbar electrically connected to the second second-direction battery row are disposed at a first end of the cell stack based on the second direction.

4. The battery assembly of claim 2, wherein the second busbar is configured to electrically connect electrode terminals of adjacent battery cells in series while electrically connecting electrode terminals provided in the plurality of battery layers in parallel.

5. The battery assembly of claim 4, wherein the first busbar and the transversal busbar are disposed in opposite positions of the cell stack based on the second direction.

6. The battery assembly of claim 2, wherein a portion of the second busbar connects electrode terminals of adjacent battery cells in each battery layer in series.

7. The battery assembly of claim 6, wherein the first busbar and the transversal busbar are disposed in a first end of the cell stack based on the second direction.

8. The battery assembly of claim 2, wherein the first busbar comprises a terminal connection portion connected to the first electrode terminals of the first second-direction battery row or the second electrode terminals of the second second-direction battery row, and an external connection portion for electrical connection to the external structure,
wherein the external connection portion is exposed to a top surface of the cell stack.

9. The battery assembly of claim 1, wherein the transversal busbar comprises a terminal connection portion connected to the first and second electrode terminals and a transversal portion crossing the reference surface,
wherein the transversal portion is electrically insulated from the battery cells.

10. The battery assembly of claim 1, wherein each of the battery cells includes a first side, a second side, and a third side,
the first side includes an area larger than an area of the second side and an area of the third side,
the first and second electrode terminals are disposed on the third side,
the first direction is a direction perpendicular to the first side,
the second direction is a direction perpendicular to the second side, and
the third direction is a direction perpendicular to the third side.

11. The battery assembly of claim 10, wherein the battery cells include a prismatic secondary battery having a hexahedral shape.

12. The battery assembly of claim 1, further comprising:
a cooling plate disposed between adjacent battery layers and configured to cool the cell stack; and
one or more adhesive member structured to fix the cooling plate and the adjacent battery layers.

13. The battery assembly of claim 12, wherein the cooling plate is fixed to the adjacent battery layers disposed on both sides in the first direction through the one or more adhesive member.

14. A battery pack comprising:
a plurality of battery assemblies;
a pack housing structured to accommodate the plurality of battery assemblies; and
an external busbar configured to electrically connect adjacent battery assemblies;
wherein each of the plurality of battery assemblies comprises:
a cell stack including a plurality of battery layers of battery cells, each battery layer including a plurality of battery cells arranged such that largest surfaces of the battery cells are oriented in a first direction, each battery layer comprising two or more third-direction battery rows each third-direction battery row including of the plurality of battery cells arranged in a third direction; and
one or more busbars coupled to the plurality of battery cells and configured to electrically connect the plurality of battery cells,
wherein the cell stack includes a first second-direction battery row and a second second-direction battery row in which the plurality of battery cells is arranged in a second direction,
the first second-direction battery row includes first electrode terminals and the second second-direction battery row includes second electrode terminals disposed to be oriented in an opposite direction to the first electrode terminals based on a reference surface between the first second-direction battery row and the second second-direction battery row, and
the one or more busbars include a transversal busbar configured to connect one or more of the first electrode terminals of the first second-direction battery row to one or more of the second electrode terminals of the second second-direction battery row and configured to traverse the reference surface.

15. The battery pack of claim 14, wherein the one or more busbars include a first busbar configured to electrically connect the first electrode terminals of the first second-direction battery row and the second electrode terminals of the second second-direction battery row to an external structure outside the cell stack.

16. The battery pack of claim 15, wherein the first busbar electrically connected to the first second-direction battery row and the first busbar electrically connected to the second second-direction battery row are disposed at a first end of the cell stack based on the second direction.

17. The battery pack of claim 16, wherein the first busbar comprises a terminal connection portion connected to the first electrode terminals of the first second-direction battery row or the second electrode terminals of the second second-direction battery row, and an external connection portion for electrical connection to the external busbar,
wherein the external connection portion is exposed to a top surface of the cell stack.
